(19) United States
(12) Patent Application Publication
(10) Pub. No.: US 2007/0034398 A1
(43) Pub. Date: Feb. 15, 2007

(54) Impact tool

(76) Inventors: Takuhiro Murakami, Ibaraki (JP); Junichi Kamimura, Ibaraki (JP); Katsuhiro Oomori, Ibaraki (JP); Shinki Ohtsu, Ibaraki (JP); Hiroto Inagawa, Ibaraki (JP); Hideki Watanabe, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/500,881

(22) Filed: Aug. 9, 2006

(30) Foreign Application Priority Data
Aug. 12, 2005 (JP) P2005-235032

(51) Int. Cl. B25D 17/24

(52) U.S. Cl. 173/210; 173/128; 173/162.1

(57) ABSTRACT

An impact tool for reducing noise without lowering the tightening ability. The impact tool gives a rotary blow force to a tip tool by mounting a rotary blow mechanism on a spindle rotatably driven by a motor and intermittently transferring the rotary blow force generated by the rotary blow mechanism from a hammer to the tip tool via an anvil, damping materials absorbing at least the vibration in the radial direction are arranged on at least one side of both supports of the axial direction of the spindle 7. The damping material is interposed between a bearing that rotatably supports the rear end portion of the spindle and an inner cover that holds the same, and an O-ring is interposed as a damping material between the front end portion of the spindle and an anvil that rotatably supports the same.

### BACKGROUND OF THE INVENTION

The present invention relates to an impact tool for doing necessary works such as tightening a screw and others by generating a rotary blow force, especially to an impact tool that reduces noise.

While rotating a tip tool by generating a rotary blow force using a motor as a driving source, an impact tool as a form of an electric tool intermittently gives a rotary blow force to the tip tool to do some works such as tightening a screw and others, but because of characteristics such as little counteraction, high tightening ability, and others, the impact tool has been widely used. However, because the impact tool has a rotary blow mechanism that generates a rotary blow force, it is a problem that there is a lot of noise while working.

FIG. 17 shows a longitudinal section of a general impact tool that has been conventionally used.

The conventional impact tool shown in FIG. 17 uses a battery pack 1 as a power source, drives a rotary blow mechanism unit using a motor 2 as a driving source, rotates an anvil 3 and gives a blow to the anvil 3, thereby intermittently transferring a rotary blow force to a tip tool 4 so as to perform some works such as tightening a screw.

In a rotary blow mechanism housed in a hammer case 5, a rotation of an output shaft of the motor 2 is reduced in speed, and is transferred to a spindle 7, and the spindle 7 is rotatably driven with a predetermined speed. Here, the spindle 7 and a hammer 8 are connected by a cam mechanism, and the cam mechanism includes a V-shaped spindle cam groove formed on an outer circumferential surface of the spindle 7, a V-shaped hammer cam groove formed on an inner circumferential surface of the hammer 8, and a ball 9 engaging cam grooves 7a and 8a.

Also, the hammer 8 is always biased to a tip direction (the right side of FIG. 17) by a spring 10, and when stopped, the hammer is located at a position with a gap with a section of the anvil 3 by the engaging of a ball 9 and the cam grooves 7a and 8a and convention portions are symmetrically formed at two places on the rotary plane where the hammer and the anvil are facing. Also, the rotation direction of a screw 11, the tip tool 4 and the anvil 3 is restricted relative to each other. Also, in FIG. 17, a symbol 14 is a bearing metal that rotatably supports the anvil 3.

Also, as described above, if the spindle is rotatably driven, the rotation is transferred to the hammer through the cam mechanism, and before the hammer 8 is rotated half, the convex portion of the hammer 8 rotates the anvil 3 by the engagement of the convex portion of the hammer 8 to the convex portion of the anvil 3, but if a relative rotation is generated between the hammer 8 and the spindle 7 by a counteractive force on the engaging, the hammer 8 starts to retreat toward the motor 2 side while compressing the spring 10 along the spindle cam groove 7a of the cam groove. Also, if the engagement is released as the convex portion of the hammer 8 jumps over the convex portion of the anvil 3 by the retreat movement of the hammer 8, the hammer 8 is rapidly accelerated toward a rotating direction and the front side by the elastic energy accumulated in the spring 10 and the operation of the cam mechanism as well as rotary force of the spindle, and moves to the front side by a biasing force of the spring 10. The hammer 8 starts to be rotated integrally as the convex portion is engaged to the convex portion of the anvil 3. At this time, because a strong rotary blow force is added to the anvil 3, the rotary blow force is transferred to the screw 11 through the tip tool 4 mounted on the anvil 3.

Later, as the same movement is repeated, the rotary blow force is intermittently transferred from the tip tool 4 to the screw 11, and the screw 11 is screwed in a wood 12, a fastening object.

However, because the hammer 8 also performs a back-and-forth movement along with a rotary movement during works using such a rotary blow tool, these movements become a source of vibration, and the wood 12, a fastening object, is excited to an axial direction through an anvil 3, the tip tool 4 and the screw 11, thereby generating a large amount of noise.

Here, among noises during works using the rotary blow tool, noise energy from the fastening object constituted a large ratio of the total noise, thereby indicating that restricting the excitation force to be a small could reduce the total noise. Hence, measures for restricting the excitation force have been frequently examined, for example, as described in Japan patent applications JP-A-1995-237152 (Patent Document 1) and JP-A-2002-254335 (Patent Document 2).

In Patent Document 1, it is described that the anvil is divided into two members, a torque transfer unit is formed between both members, and a damping material is interposed in a crevice to the axial direction, thereby reducing the force to the axial direction which is applied to the tip tool or the screw, thereby reducing noise. Here, a square concave portion at one side of both members and a square convex portion at the other side are formed respectively, and the torque transfer unit includes a square convex-concave shape or a spindle shape to connect both members so that both members cannot be rotated.

However, if the torque is hanged on- the torque transfer unit, a big friction force is generated, and by this friction force, the relative movement toward the axial direction of both members is obstructed. Hence, it was difficult to reduce the axial force applied on the tip tool or the screw, so the noise reduction effect was insufficient.

Also, in Patent Document 2, it is described that by putting electrically-driven parts such as a ball, a roller, and others as key elements and by constituting the torque transfer unit by the engagement between the groove arranged on both members divided into two of the anvil and the key element, the axial friction force between both members is written.

However, in this structure, because a surface pressure at the contact portion between the key element and the groove is pretty high, there comes to be a problem that not only the parts are quickly worn away, the structure is complicated and the manufacturing costs increase.

However, in an impact tool shown in FIG. 17, two convex portions are formed respectively to the circumferential direction by 180 degrees on surfaces where the hammer 8 and the anvil 3 are facing each other, but there has also been a problem that from the relation of the manufacturing precision, respective two convex portions are not always directly contact, and in order to go to one side direct contact state, a vibration is generated to both sides, especially to the radial direction, and because of the vibration, the noise becomes higher.

### SUMMARY OF THE INVENTION

The present invention, considering the above-mentioned problem, has an object to provide an impact tool that can reduce noise without lowering a screw-tightening ability

In order to accomplish the above object, the present invention provides an impact tool where a rotary blow mechanism is mounted on a spindle rotatably driven, a rotary blow force generated by the rotary blow mechanism is intermittently transferred to a tip tool from a hammer via an anvil, whereby the rotary blow force is given to the tip tool, and a damping material, which absorbs at least a radial vibration at least at one side of both axial supports of the spindle, is arranged.

According to the present invention The damping material is interposed between a bearing that rotatably supports one axial side of the spindle and an inner cover that holds the bearing.

Alternatively, the damping material is interposed between one axial side of the spindle and the anvil that rotatably supports the one end.

The damping material can be covered with a metal cap and the metal cap is maintained to be rotatable and movable in an axial direction of the spindle.

Further, according to the present invention the damping material includes a plurality of O-rings fitted to a circumference of one axial side of the spindle.

If a manufacturing error of a convex portion formed on the surface where a hammer and an anvil are facing occurs, then one-sided direct contact between both convex portions is generated. However, according to the present invention even if a vibration toward a radial direction is generated at the hammer and the anvil because of the one-sided direct contact, the vibration is effectively absorbed by the damping material which is arranged at least at one side of both supports to an axial direction of the spindle. Hence the vibration to the radial direction is restricted to a low level, and noise reduction is achieved.

According to the present invention, even if a vibration to a radial direction is generated at the hammer and the anvil, the vibration is absorbed by the damping material interposed between a bearing that supports one end of the spindle and an inner cover that holds the bearing. In addition according to the present invention, the same vibration is absorbed by the damping material interposed between the spindle and the anvil so that noise is restricted to a low level.

Further, according to the present invention, since a metal cap is covered on damping materials such as an O-ring and others, a large friction force is not applied between the damping material and the anvil so that loss of force is restricted to a low level.

### BRIEF DESCRIPTION OF THE DRAWINGS

FIG. 1 is a longitudinal cross-sectional view of a rotary blow mechanism unit of an impact tool in accordance with a first embodiment of the present invention.

FIG. 2 is an enlarged detailed view of part A shown in FIG. 1.

FIG. 3 is an exploded side cross-sectional view showing the supporting structure of a rear end portion of the spindle in accordance with the first embodiment of the present invention.

FIG. 4 is a side cross-sectional view of a front end portion of the spindle in accordance with the first embodiment of the present invention.

FIG. 5 is an exploded schematic view of the rotary blow mechanism unit of the impact tool in accordance with the first embodiment of the present invention.

FIG. 6 is an exploded schematic view of the rotary blow mechanism unit of the impact tool in accordance with the first embodiment of the present invention.

FIG. 7 is a side view of the anvil of an impact tool in accordance with the first embodiment of the present invention.

FIGS. 8(a) and 8(b) are cross-sectional views of a line B-B shown in FIG. 5, and FIG. 8(c) is a cross-sectional view of a rubber damper.

FIG. 9 is the same drawing as FIG. 8 showing one other form of the rubber damper.

FIG. 10 is the same drawing as FIG. 8 showing one other form of the rubber damper.

FIG. 11 is the same drawing as FIG. 8 showing one other form of the rubber damper.

FIG. 12 is the same drawing as FIG. 8 showing one other form of the rubber damper.

FIG. 13 is the same drawing as FIG. 8 showing one other form of the rubber damper.

FIG. 14 is the same drawing as FIG. 8 showing one other form of the rubber damper.

FIG. 15 is a longitudinal sectional view of a rotary blow mechanism unit of an impact tool of the second embodiment of the present invention.

FIG. 16 is an enlarged cross-sectional view of a line C-C shown in FIG. 15.

FIG. 17 is a longitudinal cross-sectional view of a conventional impact tool.

### DETAILED DESCRIPTION OF THE INVENTION

Hereinafter, the embodiments of the present invention are described with reference to the accompanying drawings.

<First Embodiment>

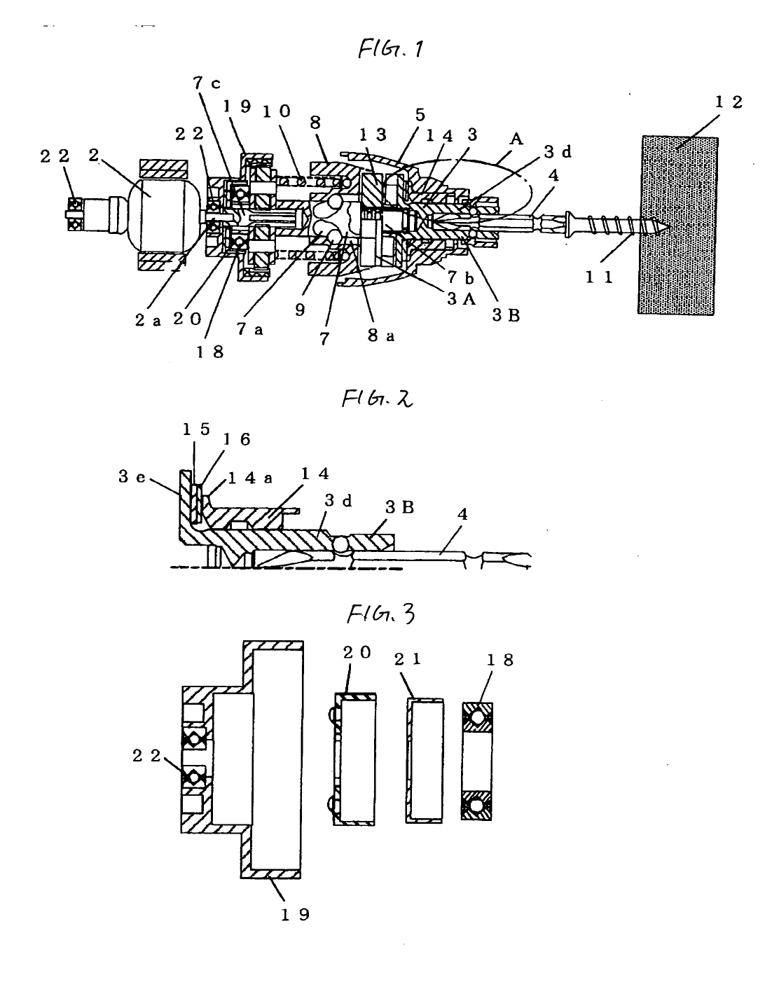

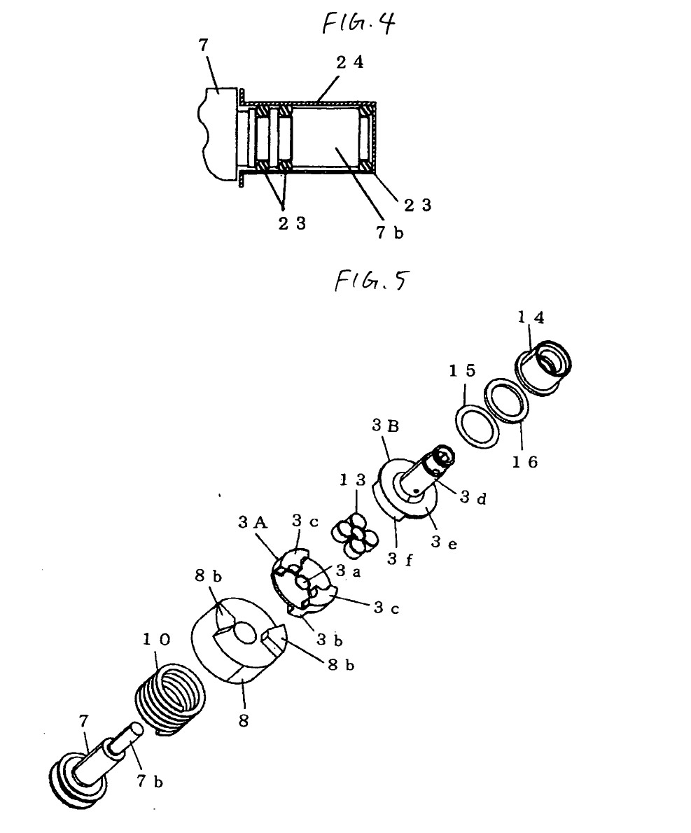

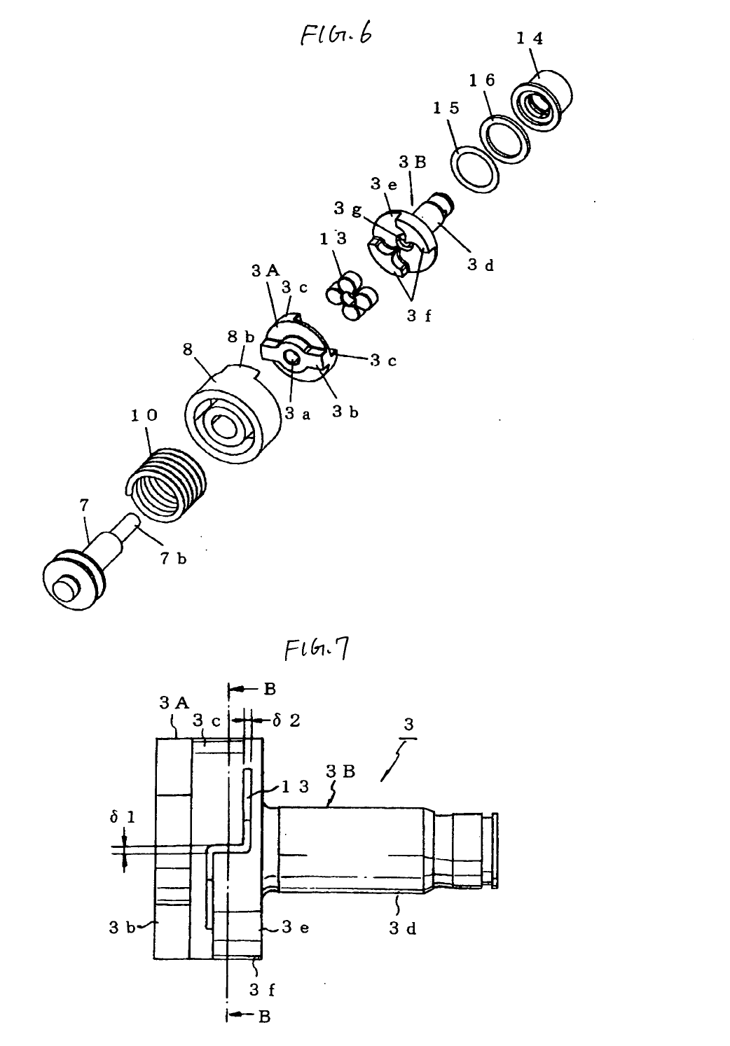

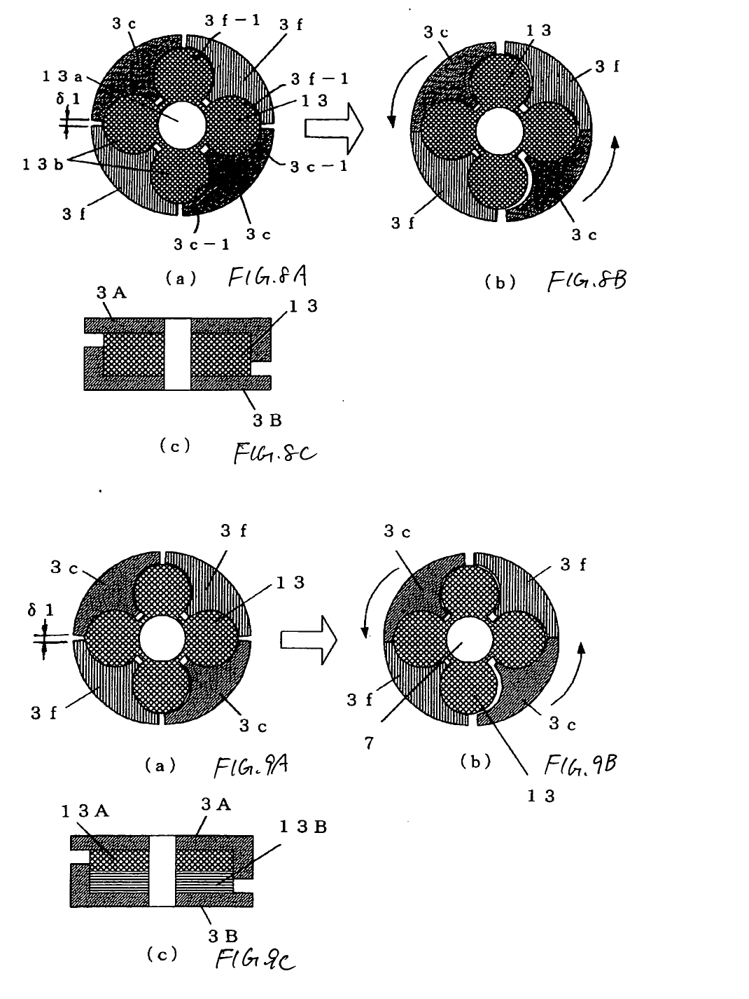

FIG. 1 is a longitudinal cross-sectional view of a rotary blow mechanism unit of an impact tool in accordance with this embodiment, FIG. 2 is an enlarged detailed view of part A shown in FIG. 1, FIG. 3 is an exploded side cross-sectional view showing the supporting structure of a rear end portion of the spindle, FIG. 4 is a side cross-sectional view of a front end portion of the spindle, FIG. 5 and FIG. 6 are exploded schematic views of the rotary blow mechanism unit of a same impact tool, FIG. 7 is a side view of the anvil, FIGS. 8(a) and 8(b) are cross-sectional views of a line B-B shown in FIG. 5, and FIG. 8(c) is a cross-sectional view of a rubber damper.

An impact tool in accordance with this embodiment is a cordless, small-sized tool that uses a battery back as a power source and a motor as a driving source, and the structure thereof is similar with the structure of a conventional impact tool shown in FIG. 17 except for a part thereof. Therefore, similar configuration with the configuration shown in FIG. 17 will not be repeatedly described in the depiction below, but only the characteristic structure of the present invention will be described.

The impact tool in accordance with this embodiment includes a damping mechanism at the anvil 3. Here, the damping mechanism directly transfers rotary torque higher than a setting value while completing a damping function in a rotation direction and an axial direction, and more specifically, the damping mechanism includes split pieces 3A and 3B in which the anvil 3 is bisectioned into two in the axial direction, and the rubber damper 13 is interposed between both split pieces 3A and 3B as a damping material therein. Further, the rubber damper 13 acts as an elastic body that disturbs a direct contact between a pawl 3C and a section of a disk-shaped portion in the vicinity of pawl 3c and a pawl 3f and a section of a flange portion 3e in the vicinity of the pawl 3f in the rotation direction and axial direction as described below.

The one split piece 3A is molded substantially in a disk shape, and an oval 3a is formed at the center thereof. And as shown in FIG. 5, a linear convex portion 3b passing through the center is integrally formed on a section of a hammer 8 of the split piece 3A. And as shown in FIG. 6, at one section of a hammer 8 (a section facing the split piece 3A), the two fan-shaped convex portions 8b are integrally formed at a position symmetrical to the circumferential direction by 180 degrees, and the convex portions 8b and the convex portions 3b formed on the split pieces 3A are intermittently disengaged every reverse rotation as described above. Further, as shown in FIGS. 6 to 8, on the other section of the split piece 3A (a section facing the other split piece 3B), two pawls 3c are integrally formed at a position symmetrical to the circumferential direction by 180 degrees, and at each pawl 3c, two circular concave portions 3c-1 are formed (Refer to FIG. 8(a).). Also, on a central portion of the hammer 8, an oval 8c is mounted.

Also, one split piece 3B is constituted by integrally forming the disk-shaped flange portion 3e on one end portion of a hollow-shaped shaft portion 3d, and at the section of the flange portion 3e (the section facing the split piece 3A), as shown in FIGS. 5, 7 and 8, like same with the pawl 3c on the split piece 3A two pawls 3f are integrally formed at a position symmetrical to the circumferential direction by 180 degrees, and at each pawl 3f, two circular concave portions 3f-1 are formed (Refer to FIG. 8(a).).

Further, as shown in FIGS. 5, 6 and 8, the rubber damper 13 is constituted by integrally arranging four circumferential damper pieces 13b in the periphery of the oval 13a formed at the center in the circumferential direction at equiangular pitch (90 degrees pitch)

Further, as shown in FIG. 1, in the anvil 3, the shaft 3d of the split piece 3B is supported to be freely rotatable by a bearing metal 14, thereby being housed in a hammer case 5, but in the section of the flange portion 3e of the split piece 3B, the rubber damper 13 is interposed therebetween, and as shown in FIG. 8(a), in the other split piece 3A, the pawls 3c and 3f are laid to be arranged by turns to the circumferential direction, and the split 3A is supported so that the relative rotation and the axial movement can be possible on the split piece 3B by the tip portion 7b of the spindle 7 inserted in the oval 3a formed at the center. Further, the tip portion 7b of the spindle 7 passes through the oval 3a of the split piece 3A and the oval 13a of the rubber damper 13 and then fits the oval 3g of the other split piece 3B.

Further, as shown in FIG. 2, the metal ring 15 and the rubber ring 16 for the thrust step are interposed between the back face of the flange portion 3e of the split piece 3B of the anvil 3 and the section of the flange portion 14a of the bearing metal 14.

However, as described above, when the anvil 3 is housed in the hammer case 5, the space, which follows the outer shape of the rubber damper 13 by pawls 3c and 3f arranged by turns in the circumferential direction of both split pieces 3A and 3B, is formed, and the rubber damper 13 is inserted and housed therein as shown in FIG. 8.

Further, under the unloaded condition in which no rotary blow force is applied, as shown in FIG. 7 and FIG. 8(a), a crevice δ is formed between pawls 3c and 3f of both split pieces 3A and 3B, and at the same time, a crevice δ2 in the axial direction is formed (Refer to FIG. 7.).

Further, at the shaft portion of the split piece 3B of the anvil 3, the tip tool 4 is detachably mounted, and the hammer 8, which includes the convex portion 8b disengaged in the convex portion 3b formed in the outer section of the split piece 3A, is always biased at the anvil 3 side (the tip direction) by the spring 10.

However, as shown in FIG. 1, the rear end portion 7c of the spindle 7 is rotatably supported by the bearing 18, and the bearing 18 is maintained by the inner cover 19, but as described in detail in FIG. 3, the rubber ring 20 for absorbing the vibration of the axial direction (the thrust direction) and the diameter direction (the radial direction) as a damping material is interposed in an inserted state by the metal ring 21. Further, as shown in FIG. 1, both ends of the output shaft (the motor shaft) 2a of the motor 2 are rotatably supported by the bearing 22, and the front end fits by insertion in the shaft center of the rear end 7c of the spindle 7.

The front end 7b of the spindle 7 at the other side fits in the oval 3g (Refer to FIG. 5). formed at the split piece 3B of the anvil 3 as described above, but as described in detail in FIG. 4, three O-rings 23 for absorbing the vibration mainly to the diameter direction (radial direction) as damping materials are interposed between the front end 7b and the spindle 7 and the split piece 3B of the anvil 3 to the axial direction with appropriate intervals. In other words, three O-rings 23 fit in the front end 7b of the spindle 7, and the cylindrical metal cap 24 having a flat part is covered in these O-rings 23. And the metal cap 24 fits by insertion at the oval 3g formed on the split piece 3B of the anvil 3 so that the metal cap is rotatable along the spindle 7 and is movable in the axial direction.

Next, the operation of the impact tool having the above-mentioned structure is described.

At the rotary blow mechanism unit, the rotation of the output shaft (the motor shaft) of the motor is decelerated via the planetary gear mechanism and is transferred to the spindle 7, and the spindle 7 is rotatably driven at a predetermined speed. Likewise, if the spindle 7 is rotatably driven, the rotation is transferred to the hammer through the cam tool, and before the hammer 8 is not caracoled, the convex portion 8b is engaged in the convex portion 3b of the split piece 3A of the anvil 3 so as to rotate the split piece 3A.

Further, if a relative rotation is generated between the hammer 8 and the spindle 7 by the reaction force by the engagement between the convex portion 8b of the hammer 8 and the convex portion 3b of the split piece 3A of the anvil 3, the hammer 8 starts to retreat toward the motor side as the hammer compresses the spring 10 along the spindle cam groove 7a of the cam mechanism. And if the engagement is released as the convex portion 8b jumps over the convex portion 3b of the anvil 3 by the retreating movement of the hammer 8, the hammer 8 is rapidly accelerated toward a rotating direction and the front side by the elastic energy accumulated in the spring 10 and the operation of the cam mechanism as well as rotary force of the spindle, and moves to the front side by a biasing force of the spring 10. And the convex portion 8b is engaged in the convex portion 3b of the anvil 3 again, and starts to rotate the anvil 3. At this time, a strong rotary blow force is added to the anvil 3, but the anvil 3 is constituted by interposing the rubber damper 13 between two split pieces 3A and 3B, and as shown in FIG. 7, since the crevice δ2 is formed between both split pieces 3A and 3B, a blow vibration is absorbed and is damped by the elastic transformation in the axial direction of the rubber damper 13 by the blow force.

Later, as the same movement is repeated, the rotary blow force is intermittently transferred from the tip tool 4 to the screw 11, and the screw 11 is screwed in the wood, the fastening object. Also, in the impact tool according to the first embodiment, because the damping mechanism completes the damping function for both the rotation direction and the axial direction, the axial vibration and the rotary vibration by the blow force are absorbed by the damping mechanism, but because the spring constant value to the axial direction is set to be lower than the spring constant value to the rotation direction, the transfer from the rotary blow mechanism to especially the wood of the vibration to the axial direction is restricted, whereby the noise is reduced.

Also, since the spring constant value in the rotation direction of the rubber damper 13 is set higher than the value of the axial direction, the rubber damper 13 can transfer the large rotary torque from the rotary blow mechanism. Also, on the rotary torque higher than the setting value, the damping mechanism makes the pawl 3c of the split piece 3A of the anvil directly contact the pawl 3f of the other split piece 3B (Refer to FIG. 8(b).), and both split pieces 3A and 3B directly transfer the rotary torque higher than the setting value to the tip tool 4 and the screw 11, so the lowering of the tightening ability is prevented.

However, due to the manufacturing error of two respective convex portions 8b and 3b formed on surfaces where the hammer 8 and the anvil 3 are facing, one-sided contact between both convex portions 8b and 3b occurs, and though the vibration in the radial direction (the radial direction) is generated at the hammer 8 and the anvil 3 by the one-sided contact, the vibration is effectively absorbed by the rubber ring 20 and the O-ring 23 as a damping material arranged on both supports to the axial direction of the spindle, so the vibration to the radial direction (the radial direction) is restricted to be low, realizing low noise. Further, the rubber ring 20 and the O-ring 23 also can absorb the vibration in the axial direction (the thrust direction).

Further, in this embodiment, because the metal cap 24 is covered on the two O-rings 23 fitted to the front end of the spindle 7, a big friction force is not applied between the O-ring 23 and the anvil 3, so the loss of force is restricted to a low level.

As the result, according the impact tool in accordance with this embodiment, noise reduction can be achieved without lowering the tightening ability.

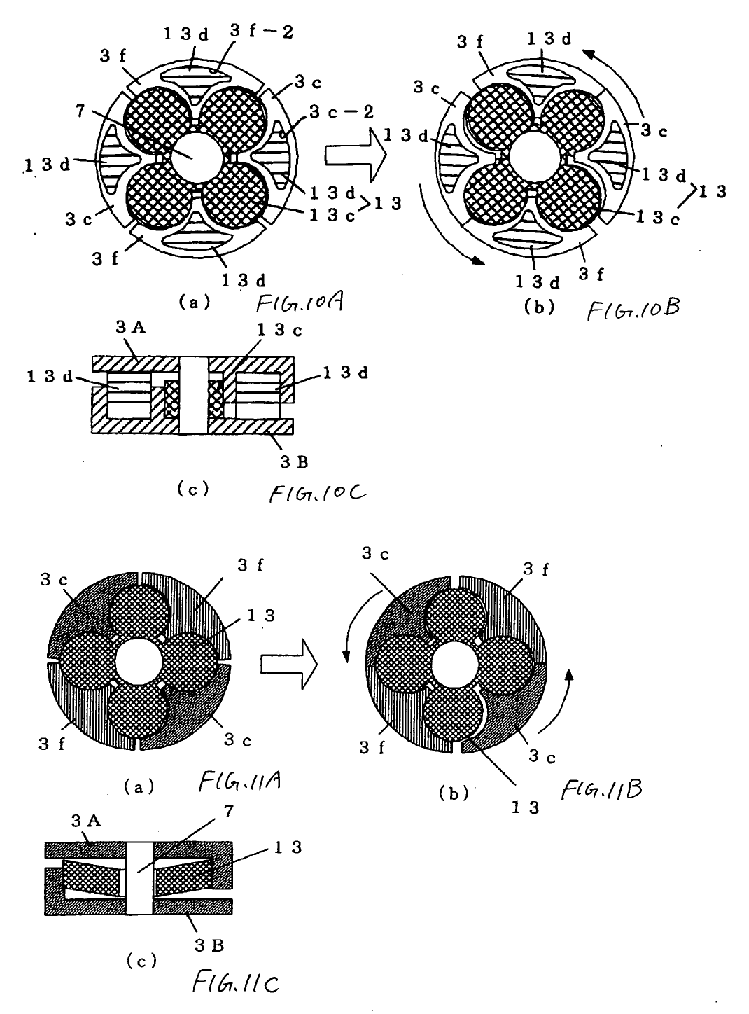

Here, various types of the rubber damper as a damping material is described in FIGS. 9 to 14. Also, FIGS. 9 to 14 are same with FIG. 8, and at each drawing, FIG. 8(a) indicates the no-load state, FIG. 8(b) indicates the load state where the rotary torque higher than the setting value is applied, and FIG. 8(c) indicates the section of the rubber damper.

In the form shown in FIG. 9, the rubber damper 13, as shown in FIG. 9(c), is constituted by laminating elastic bodies 13A and 13B of two layers having different spring constant values. And the damper is constituted so that the side of which spring constant value is higher among the elastic bodies 13A and 13B is inserted in a rotation direction at the pawls 3c and 3f, and the spring constant value in the rotation direction is set higher than the spring constant value to the axial direction. In other words, the rubber damper 13 is set to make the transformation to the axial direction than the rotation direction easy. Also, the elastic bodies 13A and 13B constituting the rubber damper 13 may be formed integrally or separately.

In the form shown in FIG. 10, the rubber damper 13 includes totally four elastic bodies 13d inserted in fan-shaped holes 3c-2 and 3f-2 formed on each pawl 3c and 3f of the split pieces 3A and 3B of the anvil 3 as well as elastic bodies 13c shown in FIG. 6. Here, the elastic bodies 13c is arranged with a crevice between split pieces 3A and 3B in the axial direction and the damping in the axial direction is just performed by the elastic bodies 13d. Therefore, the spring constant value in the whole rotation direction of the rubber damper 13 is set to be higher than the spring constant value in the axial direction.

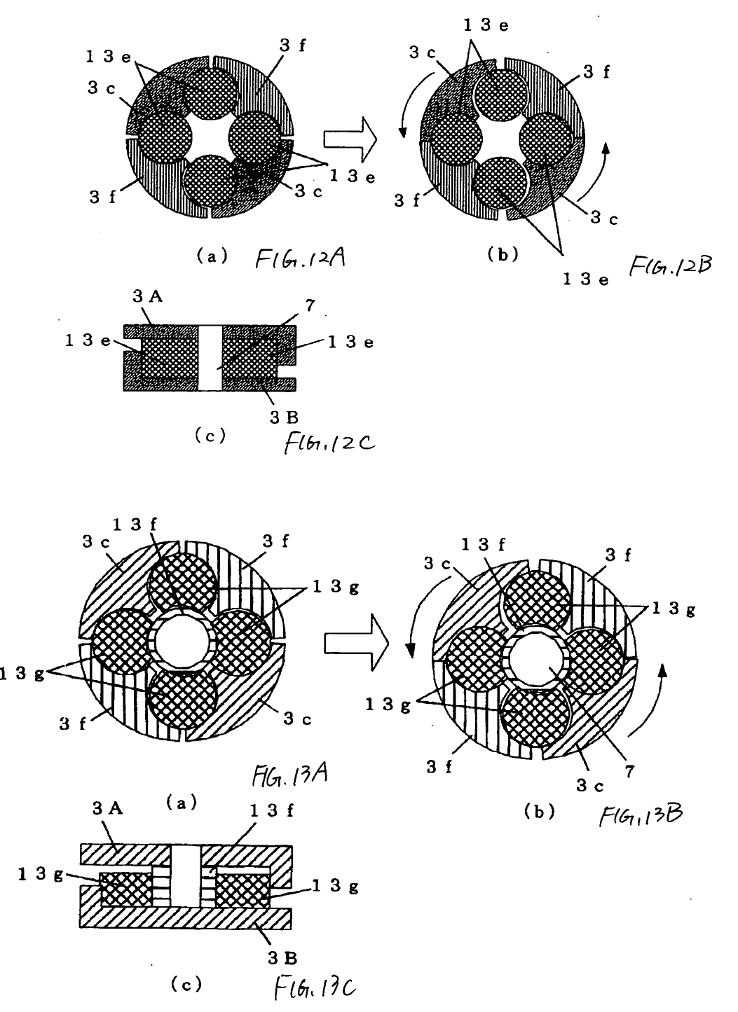

Further, in the form shown in FIG. 11, the shape viewed from the axial direction is molded in a disk spring shape which is transformable in the axial direction as showing the elastic body 13 with the shape shown in FIG. 6 in FIG. 11(c). Therefore, the spring constant value in the rotation direction of the rubber damper 13 can be set to be higher than the spring constant value in the axial direction.

Further, at the form shown in FIG. 12, the rubber damper 13 includes the elastic bodies 13f of the sleeve shape at the center and the four independent cylindrical elastic bodies 13g arranged in the vicinity of the elastic bodies 13f, and if the transfer torque of the split piece 3A of the anvil 3 exceeds a predetermined value, as shown in FIG. 12(b), since the rubber damper 13 is elastically transformed so that the pawl 3c of one-sided split piece 3A is directly contacted (metallic contact) with the pawl 3f of the other split piece 3B, the rotary torque is directly transferred from one split piece 3A to the other split piece 3B, and the anvil 3 transfers the rotation to the tip tool through the integral rotation. In this case, the elastic bodies 13g are arranged between split pieces 3A and 3B with a crevice to the axial direction, and the damping in the axial direction is performed only by the elastic body 13f. Therefore, the elastic constant value in the rotation direction of the whole rubber damper 13 is set to be higher than the elastic constant value in the axial direction.

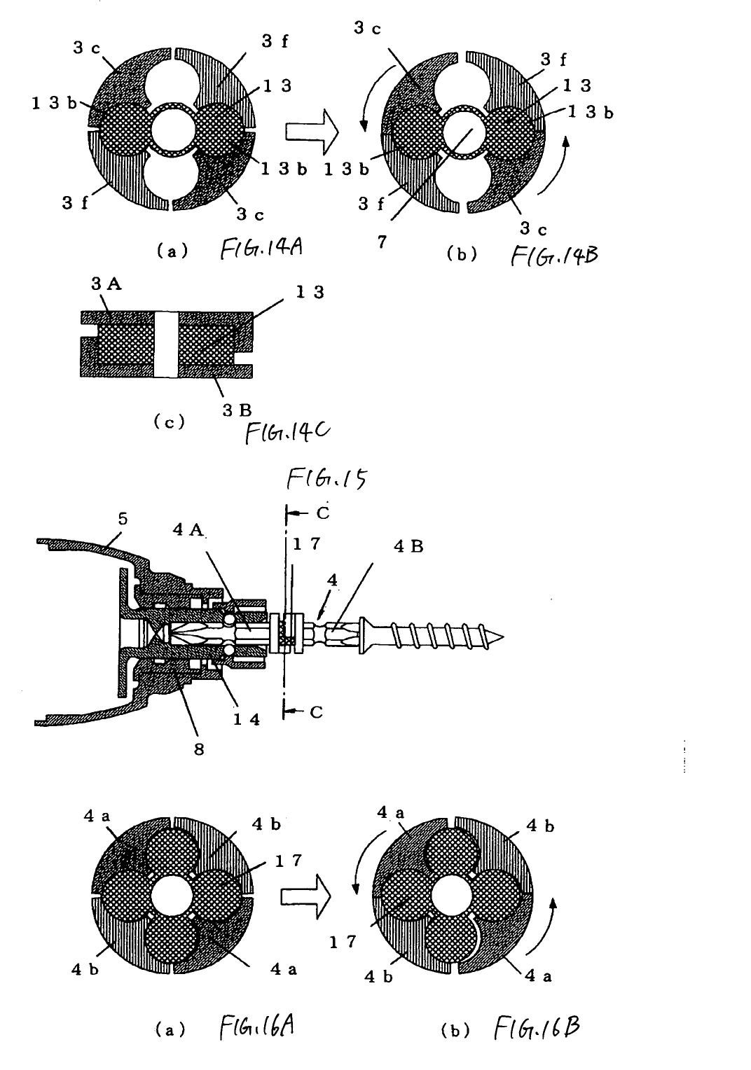

At the form shown in FIG. 13, the rubber damper 13 includes a sleeve-shaped elastic bodies 13f and four independent elastic bodies 13g arranged in the vicinity of the elastic body 13f, and if the transfer torque of the split piece 3A of the anvil 3 exceeds a predetermined value, as shown in FIG. 13(b), the rubber damper 13 is elastically transformed so that the pawl 3c of one split piece 3A is directly contacted with the pawl 3f of the other split piece 3B, whereby the rotary torque is directly transferred from one split piece 3A to the other split piece 3B, and the anvil is integrally rotated, thereby transferring the rotation to the tip tool 4. In this case, since one elastic body 13f and four elastic bodies 13g making up the rubber damper 13 are independently constituted respectively, the whole characteristics of the rubber damper 13 can be changed as necessary by setting these spring constant values arbitrarily.

Further, in the form shown in FIG. 14, the number of cylindrical damper pieces 13b making up the rubber damper 13 is reduced to two pieces, these damper pieces 13b are integrally arranged at a position symmetrical to the circumferential direction by 180 degrees, and especially when a high transfer torque is not necessary, the damper pieces can be very appropriately adopted.

<Second Embodiment>

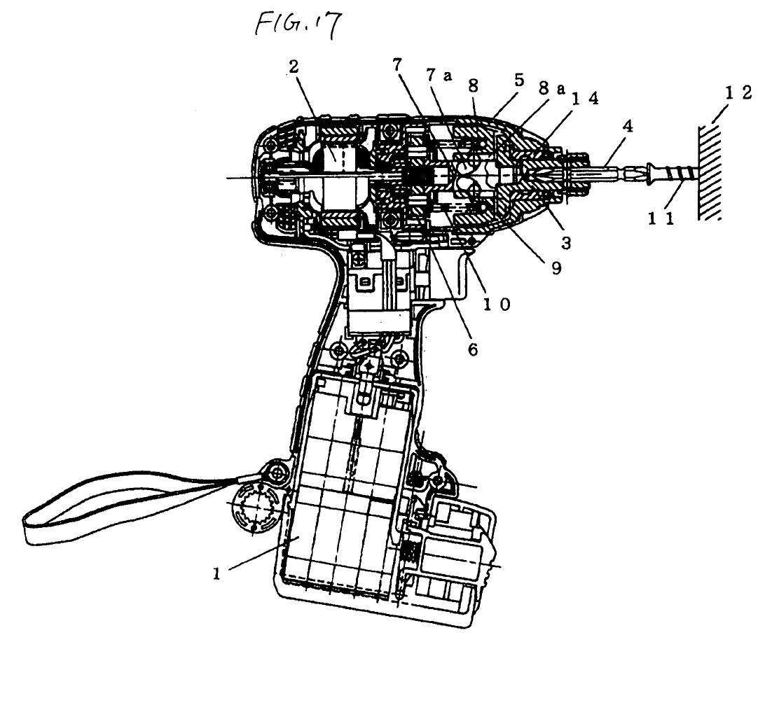

Next, the second embodiment of the present invention is described with reference to FIGS. 15 and 16. And FIG. 15 is a longitudinal cross-sectional view of a rotary blow mechanism unit of an impact tool of the second embodiment, and FIG. 16 is an enlarged cross-sectional view of a line C-C shown in FIG. 15. And in these figures, to the same elements as shown in FIGS. 1 and 2, the same symbols are given.

The impact tool in accordance with this embodiment includes a damping mechanism at the tip tool 4, and though not shown, elastically supports the front and rear ends with a damping material to absorb the vibration of the radial direction (the radial direction). Here, as described in this embodiment, the damping mechanism directly transfers the rotary torque higher than the setting value, and more specifically, the tip tool 4 includes split pieces 4A and 4B divided into two in the axial direction, and the rubber damper 17 is interposed between both split pieces 4A and 4B as a damping material.

In other words, as shown in FIG. 16, at the section of the split piece 4A of the tip tool 4, the two pawls 4a similar with those in accordance with this embodiment are integrally formed, and on the section of the other split piece 4B facing the section of the split piece 4A, the same two pawls 4b are integrally formed. And into the space formed by pawls 4a and 4b arranged by turns in the circumferential direction of both split pieces 4A and 4B, the rubber damper 17 is injected. Also, the reason why the rubber damper 17 is injected is to prevent the dropout of the split piece 4B of the tip tool 4.

Also, in the impact tool in accordance with the second embodiment, the spring constant value in the rotation direction of the rubber damper 17 is set to be high than the value in the axial direction and the rubber damper 17 completes the damping function for both the rotation direction and axial direction. In this case, since the spring constant value to the axial direction of the rubber damper 17 is set to be lower than the spring constant value in the rotation direction, the spread from the rotary blow mechanism, the vibration source, especially to the wood of the vibration in the axial direction, is restricted, whereby the noise is reduced.

Further, since the spring constant value in the rotation direction of the rubber damper 17 is set to be higher than the value in the axial direction, the rubber damper 17 can transfer a high rotary torque from the rotary blow mechanism. Also, the damping mechanism makes the split piece 4a of the tip tool 4 directly contact the pawl 4b of the other split piece 4B (Refer to FIG. 16(b).), and both split pieces 4A and 4B are integrally formed and directly transfer the rotary torque higher than the setting value to the screw 11 so as to rotate the screw, whereby the lowering of the tightening ability is prevented.

And due to the manufacturing errors of two respective convex portions formed on the surface facing each other of the hammer and anvil, the one-sided direct contact between both convex portions is generated, and though the vibration of the radial direction (the radial direction) is generated at the hammer and the anvil due to the one-sided direct contact, the vibration is effectively absorbed by the damping material arranged in both supports in the axial direction of the spindle, whereby the vibration to the radial direction (the radial direction) is restricted to be low and the noise is reduced.

Therefore, in the impact tool in accordance with the second embodiment, the noise is reduced without lowering the tightening ability.

Industrial Applicability

The present invention is especially useful for reducing noise by applying to impact tools such as a hammer drill for performing necessary works by generating rotary blow forces.

What is claimed is:

1. An impact tool for giving a rotary blow force to a tip tool by mounting a rotary blow mechanism onto a spindle rotatably driven by a motor and intermittently transmitting the rotary blow force generated by the rotary blow mechanism to the tip tool from a hammer via an anvil, said impact tool comprising:
a damping material that absorbs at least radial-direction vibration on at least one side of both axial supports of the spindle.

2. The impact tool according to claim 1,
wherein the damping material is interposed between a bearing that rotatably supports one axial side of the spindle and an inner cover that holds the bearing.

3. The impact tool according to claim 2, wherein even if a vibration to a radial direction is generated at the hammer and the anvil, vibration is absorbed by the damping material interposed between the bearing and the inner cover that holds the bearing.

4. The impact tool according to claim 1,
wherein the damping material is interposed between one axial side of the spindle and the anvil that rotatably supports the same.

5. The impact tool according to claim 2,
wherein the damping material is interposed between one axial side of the spindle and the anvil that rotatably supports the same.

6. The impact tool according to claim 4, wherein the same vibration is absorbed by the damping material interposed between the spindle and the anvil so that noise is restricted to a low level.

7. The impact tool according to claim 5, wherein the same vibration is absorbed by the damping material interposed between the spindle and the anvil so that noise is restricted to a low level.

8. The impact tool according to claim 4,
wherein the damping material is covered with a metal cap and the metal cap is maintained to be rotatable and movable in an axial direction of the spindle.

9. The impact tool according to claim 5,
wherein the damping material is covered with a metal cap and the metal cap is maintained to be rotatable and movable in an axial direction of the spindle.

10. The impact tool according to claim 8, wherein the metal cap prevents a large friction force from being applied between the damping material and the anvil so that loss of force is restricted to a low level.

11. The impact tool according to claim 9, wherein the metal cap prevents a large friction force from being applied between the damping material and the anvil so that loss of force is restricted to a low level.

12. The impact tool according to claim 4,
wherein the damping material includes a plurality of O-rings fitted to one axial circumference of the spindle.

13. The impact tool according to claim 5,
wherein the damping material includes a plurality of O-rings fitted to one axial circumference of the spindle.

14. The impact tool according to claim 8,
wherein the damping material includes a plurality of O-rings fitted to one axial circumference of the spindle.
